(19) United States
(12) Patent Application Publication
(10) Pub. No.: US 2013/0086773 A1
(43) Pub. Date: Apr. 11, 2013

(54) SURGICAL INSTRUMENT PACKAGING CLIP SYSTEM

(71) Applicant: J. Michael Cude, College Grove, TN (US)

(72) Inventor: J. Michael Cude, College Grove, TN (US)

(73) Assignee: Coeur, Inc., Lebanon, TN (US)

(21) Appl. No.: 13/267,995

(22) Filed: Oct. 7, 2011

(51) Int. Cl. F16G 11/10

(52) U.S. Cl. 24/132 R; 24/115 K

(57) ABSTRACT

A clip used in connection with a tube having sections arranged to form a coil, the clip comprising a first section and a second section joined at one end by a hinge and at an opposite end by a clasp to define a channel between the first and second sections, and a first pair of ridges where each ridge is an opposing relationship with the other and extends inwardly from a respective first and second section partially into the channel defining a gap therebetween and dividing the channel into channel sections, whereby the sections of the tube are received in the channel sections and extend toward contact with each other in the gap formed between the ridges.

### TECHNICAL FIELD

The present invention generally relates to clips used to organize packaging for surgical devices. More particularly, the present invention relates to a clip used to secure a tube for packaging surgical devices in an adjacent relationship such as when the tube is in a coiled configuration.

### BRIEF DESCRIPTION OF THE DRAWINGS

FIG. 1 is a perspective view of a clip according to the concepts of the present invention depicted in an open position;

FIG. 2 is a partially schematic perspective view of a clip according to the concepts of the present invention in a closed position with a tube section located therein;

FIG. 3A is a front elevational view of a clip according to the concepts of the present invention depicted in an open position;

FIG. 3B is a front elevational view of a clip according to the concepts of the present invention depicted in a closed position showing details of the arrangement of two sections of tube within the clip where the lateral extremities of the adjacent sections of each tube extend into a gap formed by ridges within the clip;

FIG. 4 is a perspective view of an alternative embodiment of a clip according to the concepts of the present invention depicted in an open position;

FIG. 5 is a perspective view of an alternative embodiment of a clip similar to FIG. 4 with the clip shown in a closed position;

FIG. 6 is a front elevational view of an alternative embodiment of the clip shown in FIG. 5;

FIG. 7 is a perspective view depicting plural clips according to various embodiments of the present invention securing sections of a tube therein to form a coil of tubing;

FIG. 8A is a top perspective view of a clip according to another embodiment of the present invention having open primary and secondary channels and a hanger according to one embodiment of the present invention extending from an end of the clip;

FIG. 8B is a bottom perspective view similar to FIG. 8A;

FIG. 9A is a top perspective view of another embodiment of a clip according to the concepts of the present invention having open primary and secondary channels and an alternative hanger embodiment extending from one end of the clip;

FIG. 9B is a bottom perspective view similar to FIG. 9A;

FIG. 10 is a perspective view depicting a clip according to the embodiment depicted in FIGS. 8A and 8B showing tubing and an adapter secured in the primary channels of the clip, an accessory secured in a secondary channel of the clip, and attachment of an accessory clip to the hanger;

FIG. 11 is a perspective view depicting a clip according to the embodiment depicted in FIGS. 9A and 9B showing tubing and an adapter secured in the primary channels of the clip, an accessory secured in a secondary channel of the clip, and attachment of an accessory clip to the hanger according to another embodiment of the present invention; and

FIG. 12 is a perspective view of a clip according to an alternative embodiment of the present invention having a detachable adapter attached to the clip in an open channel, where the detachable adapter includes a boss received in an open channel of the clip and an arm extending laterally outward therefrom having an end adapted to receive a portion of a surgical instrument or other accessory.

### DETAILED DESCRIPTION OF THE INVENTION

A clamshell clip according to the concepts of the present invention is generally indicated by numeral 10 in the accompanying drawings. Clip 10 may be used in connection with a tube T used to package an elongate surgical instrument or other device such as a catheter, lumen, guide wire, and the like. These devices will be collectively referred to as an instrument I.

Elongate instruments may be packaged in a coiled configuration to prevent damage to the device during storage or transport and to facilitate their use in surgery. To that end, it is known to package elongate instruments in a tube to maintain the instrument in a closed environment that may be sealed after sterilization and protect the instrument during transport. To that end, the tube used to package the instrument is often coiled to store the instrument in a coiled configuration that facilitates its use during surgery and prevents kinking. To maintain the coiled configuration of the tube, it is known to use clips that define parallel channels into which a section of tube is seated to form concentric loops of the coil. One existing clip has three U-shaped sidewalls that define parallel channels for receiving the tube. While this clip is suitable for holding the tube in a coiled configuration, the spacing between the tubes created by the upstanding sidewalls that separate them has the effect of increasing the size of the packaging needed to house the tube in a coiled configuration.

Typically, the tube, once coiled, is sealed in a plastic bag or similar packaging. It will be appreciated that additional spacing between the tubes increases the effective diameter of the coil such that the packaging must be larger. Also, the space between tubes formed by the prior art clip may be more likely to snag or allow an object to dislodge the tube from the clip. Consequently, it is desirable to minimize the spacing between adjacent tubes in a clip.

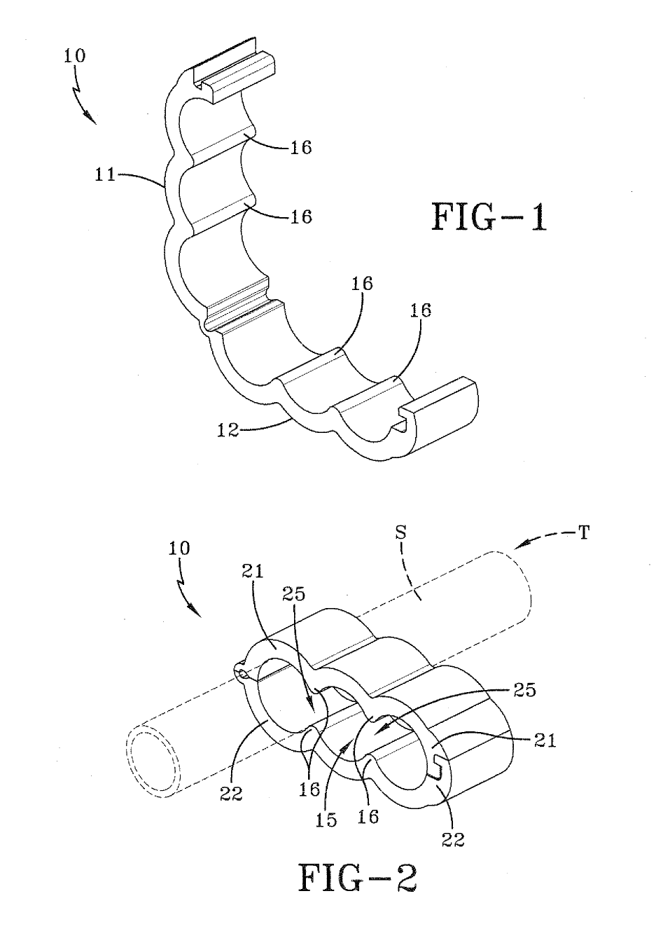

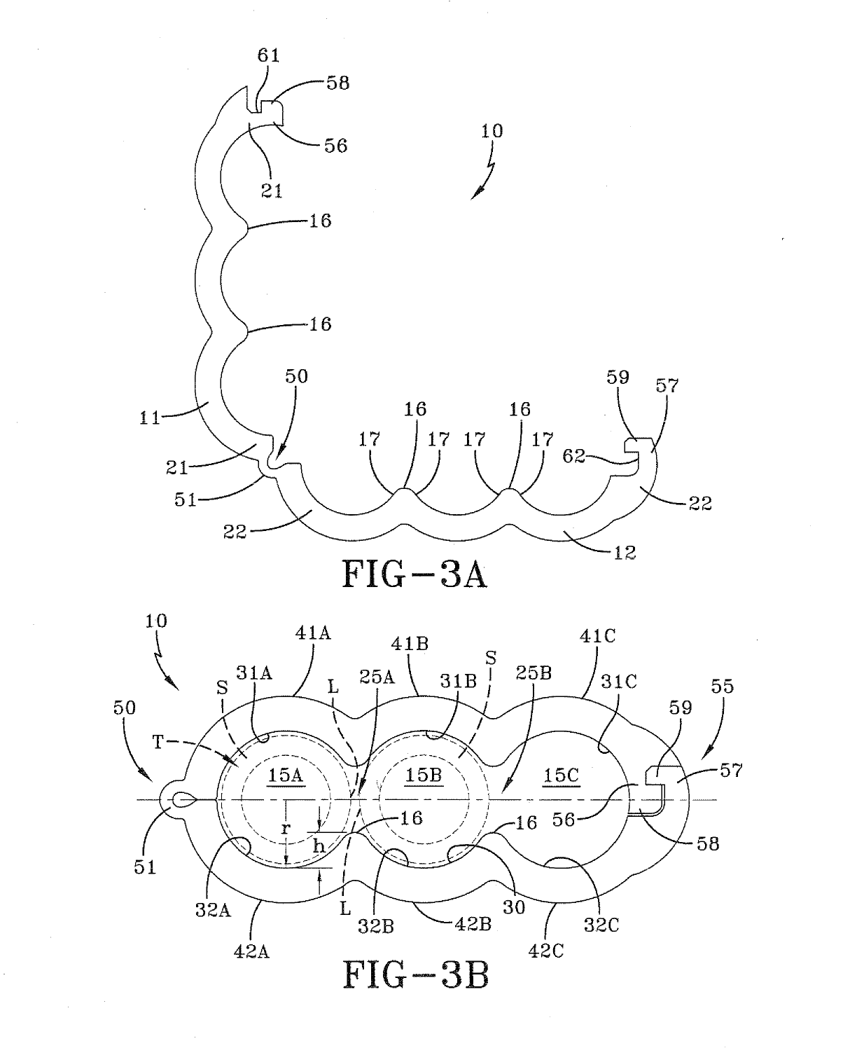

With reference to FIGS. 1-3B, a clamshell clip 10 according to the concepts of the present invention defines channel sections that are only partially separated such that the sections of tube positioned within the channel sections are separated by a minimal gap or permitted to contact each other in an adjacent relationship. The clip 10 includes a first section 11 and a second section 12. First section 11 and second section 12 have inwardly extending end portions 21, 22 that when joined define the radial outward extremities of a channel 15 defined by clip 10. As best seen in FIG. 3B, channel 15 may be divided into plural sections (15A, 15B, 15C) by one or more ridges 16 that extend inwardly from each section 21, 22 of clip 10. Ridges 16 may be any projection that extends inward into channel 15 to divide channel 15 into sections. When used in connection with a tube T having a circular cross-section, ridges 16 may have a some what triangular shape that helps fill the voids created between adjacent sections S of the tube T. As shown in FIG. 3A, ridges 16 may have curved surfaces 17 to conform to the circular cross-section of tube T. Ridges 16 extend inward a height h less than a radius r of tube T so that the ridges 16 do not separate that section S of tube T, as described more completely below.

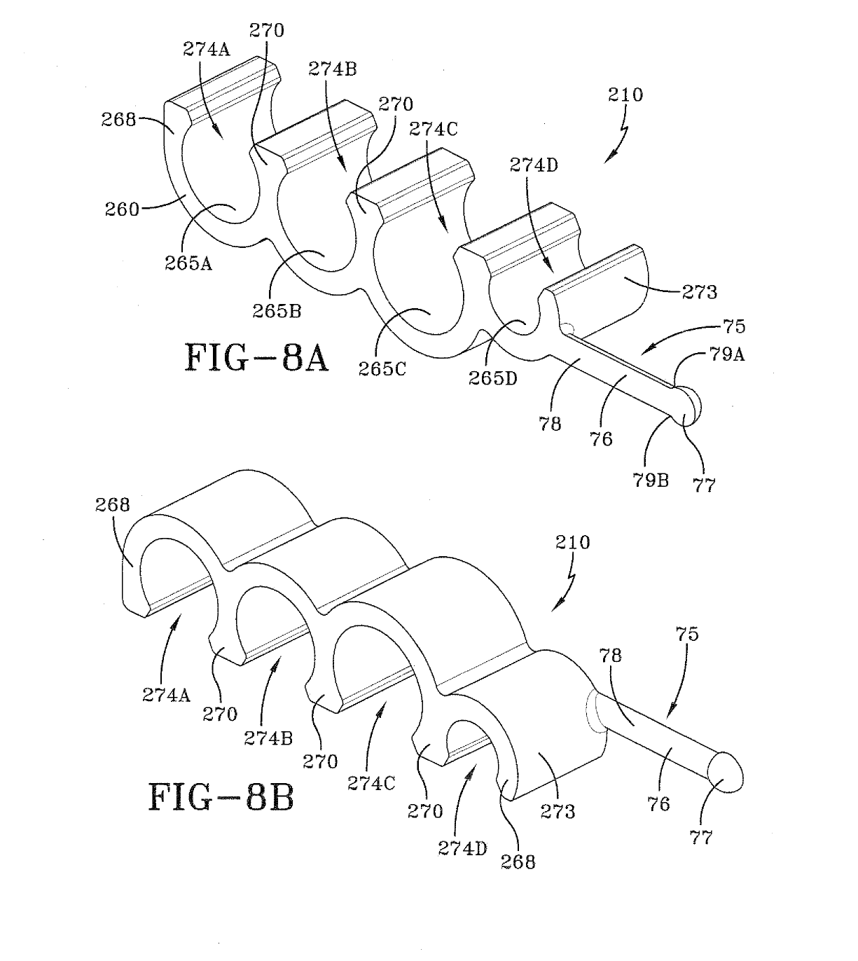

In the example shown in FIG. 2, two pairs of ridges 16 extend inwardly towards each other from opposing sections 11, 12 dividing the channel 15 into three channel sections 15A, 15B, 15C (FIG. 3B). Ridges 16 may extend inward to a lesser extent than end portions 21, 22 to define a gap 25 between ridges 16. Relative to the tube T, ridges 16 may extend a distance less than the radius R of tube T. In this way, gap 25 between opposing ridges 16 is formed on either side of an axis extending laterally through the centers of adjacent sections S of tube T. In this way, as best shown in FIG. 3B, the lateral extremities L of sections S may extend into the gap 25 allowing closer arrangement of the tube T. Gap 25 allows tube sections S within channel 15 to be immediately adjacent to each other to minimize any space between adjacent sections S of tube T and potentially allow the sections S of the tube T to contact each other within gap 25. In the example shown, two gaps 25A, 25B are formed respectively between sections 15A and 15B and 15B and 15C by the pairs of ridges 16. As best shown in FIGS. 3B and 7, with section S of tube T situated in this manner, sections S are held in close proximity to each other minimizing the space between sections S. Sections S are secured within clip 10 by attaching clip sections 11,12 together. For Example, a hinge 50 may be located at one end, of clip 10, such that, sections S of tube T may be readily positioned within clip 10 and secured by latching a clasp 55 opposite hinge 50. In this way, as shown in FIG. 7, sections S of tube T may be held in a closely packed coil that minimizes the coil diameter by minimizing the spacing between adjacent section S within the coil C. As will be appreciated, multiple clips 10 may be used in forming coil C including clips of different types as discussed more completely below.

With reference to FIG. 3B, the interior surface 30 defined by the cooperating clip sections 11, 12 of clip 10 may be contoured to generally conform to the shape of the cross-section of tube T. For example, as shown in FIG. 3B, when a circular cross sectioned tube T is used, first section 11 and second section 12 may be provided with arcuate interior surfaces 31A, 31B, 31C, 32A, 32B, 32C that conform to the circular cross-section of the tube T located within channel sections 15A, 15B, 15C. The outer surface of sections 11, 12 may have a similar arcuate shape to form lobes 41A, 41B, 41C, 42A, 42B, 42C on the respective sections 11, 12. In some instances, multiple tubes may be coiled together and have different cross-sections or diameters. To that end, the channel sections 15A, 15B, 15C may be of different cross-section and/or diameter/lateral dimension to accommodate tubes of varying cross-section and/or diameter/lateral dimension.

The sections 11, 12 may be secured together in a number of manners including clasps that secure each of the end sections 11, 12 to each other. As shown, sections 11, 12 are joined at one end by a hinge, generally indicated by the number 50. Hinge 50 may be a living hinge formed integrally with sections 11, 12. To that end hinge 50 may include a flexible band 51 extending between clip sections 11, 12. Band 51 may have a thinner cross section than clip sections 11, 12 to impart flexibility to hinge 50.

At the end of the clip 10 opposite hinge 50, a releasable clasp generally indicated by the number 55 may be provided to allow selective opening and closing of the channel 15 during assembly of the tube sections S therein. In the embodiment shown, clasp 55 is formed as part of clip 10 by providing interlocking clasp sections 56, 57 respectively on clip sections 11, 12. As best shown in FIG. 2, clasp sections 56, 57 may be generally L-shaped with each leg 58, 59 of the L defining a groove 61, 62 adjacent thereto for receipt of the leg 58, 59 of the opposing clasps section 56, 57. In this way, the L-shaped sections 56, 57 overlap each other and oppose opening of clip 10.

The clip 10 may be made of any suitable rigid material including, for example, metals, plastics, and the like. In the example shown, clip 10 is constructed of high density polyethylene. The clip 10 may have any shape that defines a suitable channel 15.

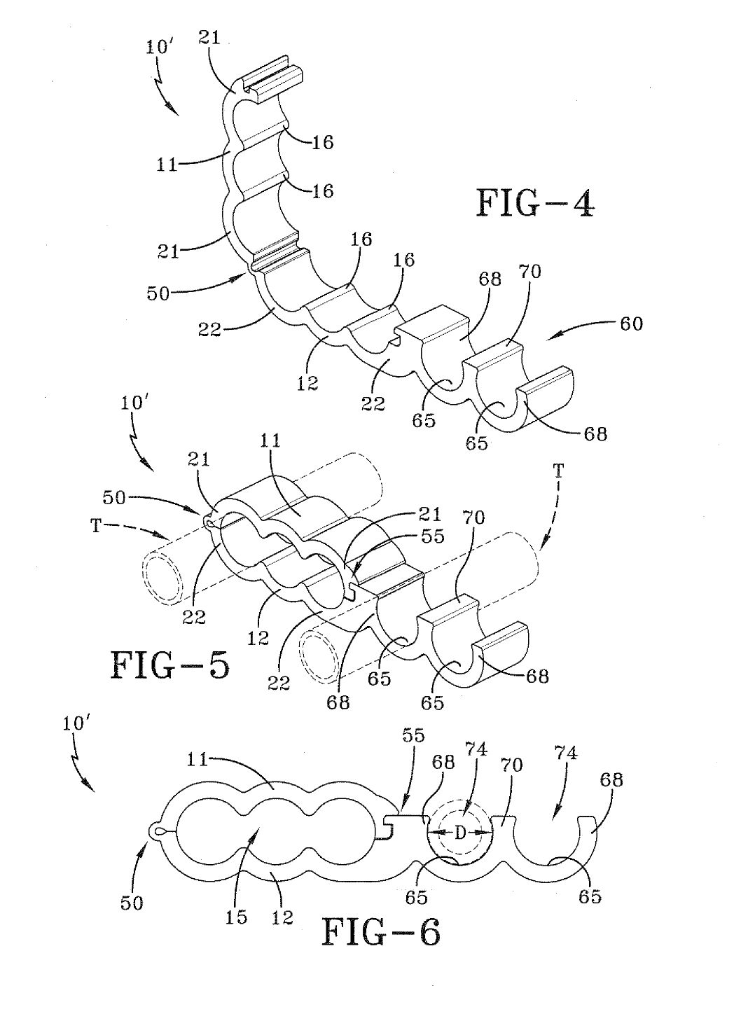

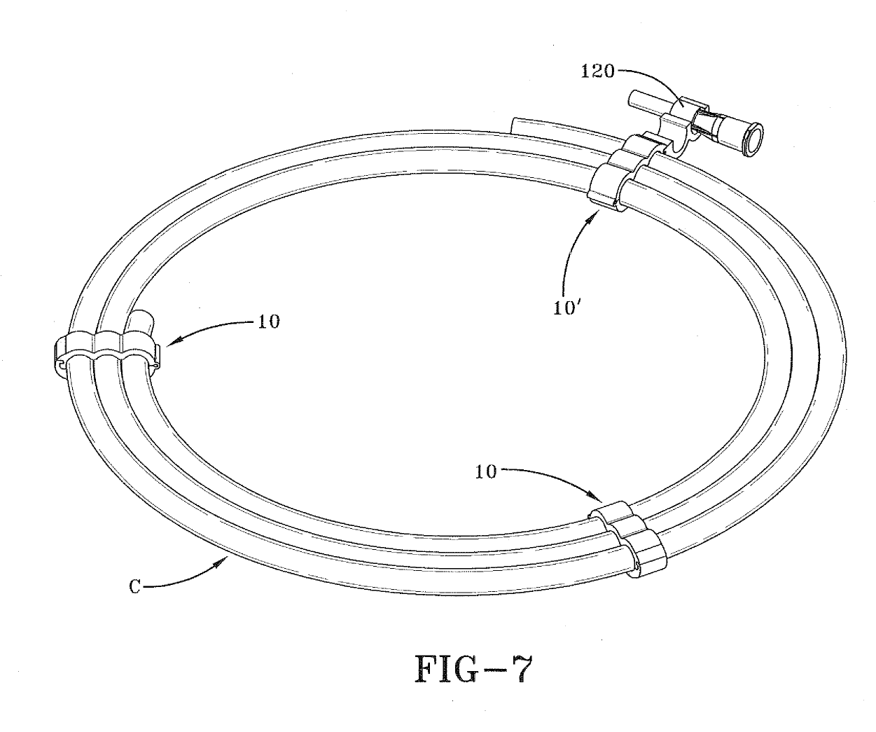

FIGS. 4-6 depict an alternative clip 10 that includes an additional open clip portion, generally indicated by the number 60. With the exception of the additional open clip portion 60, the structure of clip 10′ remains largely the same as the previously described embodiment. Therefore, like numbers are used to refer to like structures in clip 10′. To the extent that these portions are not described in detail herein, reference is made to the previous embodiment. Open clip portion 60 has one or more open channels 65 and extends from one end of the clip 10′. For example, as shown in FIG. 6, an open clip portion 60 having a pair of open channels 65 is attached to second section 12 of clip 10′ and extends outwardly from end portion 22, on the clasp side of the clip 10′ such that the open channels 65 do not interfere with operation of the hinge 50. In the example shown, open channels 65 are generally U-shaped and defined by walls 68 and a divider 70 extending upwardly between walls 68. Divider 70 and walls 68 extend to an extent greater than the radius of the tube T to be housed within the channels. In this configuration, the interior surface 76 of walls 68 and divider 70 may be made arcuate to conform to the circular shape of tube T and extend radially inwardly relative to the channel 65 as walls 68 and divider 70 extend above the center of the channel 65. In this way, a mouth 74 is formed between divider 70 and walls 68 of the channels 65 that is slightly narrower than the diameter D of tube T. The practical effect being that tube T must be forced into the channels 65 defined by the U-shaped members 68 causing the mouth 74 to open to accept the diameter D of tube T and retract to hold tube T in place. It will be appreciated that the dimensions of the U-shaped channels 65 may vary from that of tube T, for example, when used to secure accessories or other members that have a different lateral dimension than tube T. Similarly, the walls 68 and divider 70 may have interior surfaces that conform to the cross sections of the particular object housed within them including non-circular tubes, adaptors, or end caps commonly used in connection with the packaging of an elongate instrument.

As shown in FIG. 7, alternative clip 10′ may be used in connection with a tube T to form a coil C and provide additional channels extending laterally outward relative to the coil C to receive a portion of the tube T or other accessories or attachments used in connection with or packaged with an elongated surgical instrument. By way of example, a flushing device 120 is shown attached in the outer most channel 65 of open clip portion 60.

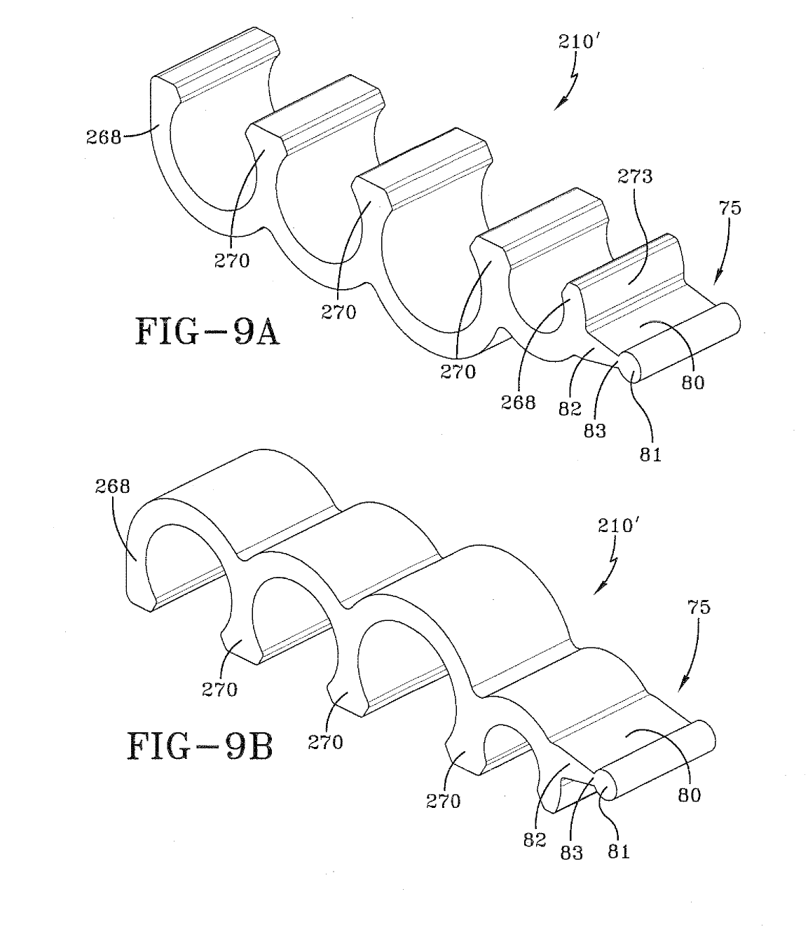

As a further alternative, the clip may be provided with a hanger 75 that facilitates attachment of accessory clips and other similar items to the coil. While hanger 75 is shown in FIGS. 8-9 as extending from an end of an open clip 210. Hanger 75 may extend from the previously described clam-shell clip 10 or open clip portion 60 of clip 10′. In the example shown, an open clip 210 is provided having plural U-shaped channels, which may be configured as described in connection with open clip portion 60. In the example shown in FIGS. 8A and 8B, open clip 210 includes a base 260 having upstanding walls 268 and dividers 270 that defines plural U-shaped channels 265A-D. As discussed with respect to the open clip portion 60 above, the walls 268 and dividers 270 of base 262 may be configured to define a mouth 274 that has a lateral dimension that is smaller than the diameter of the tube or other object to be located within the channel 265. Also, as shown in connection with channel 265D, a diameter of the channels 265 may be varied to conform to the shape of an object to be located within the channel 265. For example, channel 265D is located at one end of clip 210 and has a smaller cross section or lateral dimension than channels 265A-265C. In application, a tube T may be coiled such that sections S fit within channels 265A-265C with a smaller accessory or other object, like a flushing device 120 (FIG. 7) may be attached in channel 265D. Since the structure of the open clip 210 is similar to open clip portion 60 described above, like numbers have been used to refer to like components and to the extent that these components are not described in detail herein, reference is made to the previous description,

As shown in FIGS. 8 and 9, a hanger, generally indicated by the number 75 may extend laterally outward from an end 273 of clip 210. With reference to FIGS. 8A and 8B, hanger 75 may be in the form of a post 76. Post 76 may extend outward from an end 273 of open clip 210 as shown. Post 76 may have an end portion 77 that is attached to clip 210 by a tab 78. In the example shown in FIGS. 8A and 8B, end portion 77 is larger than tab 78 and forms shoulders 79A, 79B that project above and below tab 78. These shoulders 79A, 79B may help locate objects on tab 78 or provide a gripable surface adjacent to tab 78 on which clips or other similar accessories may be attached. End portion 77 may be in the form of a hemi-spherical bead as shown. As best shown in FIG. 10, an accessory clip 85 may be attached to the post by gripping the tab 78 between jaws 87. As shown, tab 78 may have a vertical dimension sized to fit within a circular recess 86 formed in the clip 85, which allows the shoulder 79A, 79B of end portion 77 to act as a lateral stop to prevent the clip 85 from sliding off of the post 76.

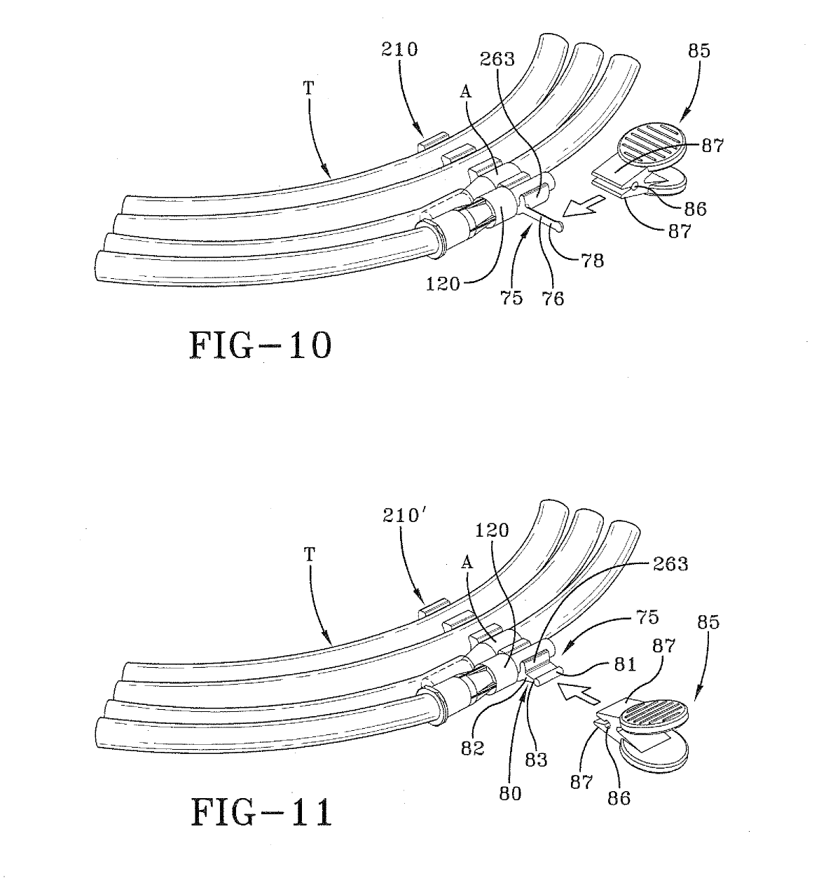

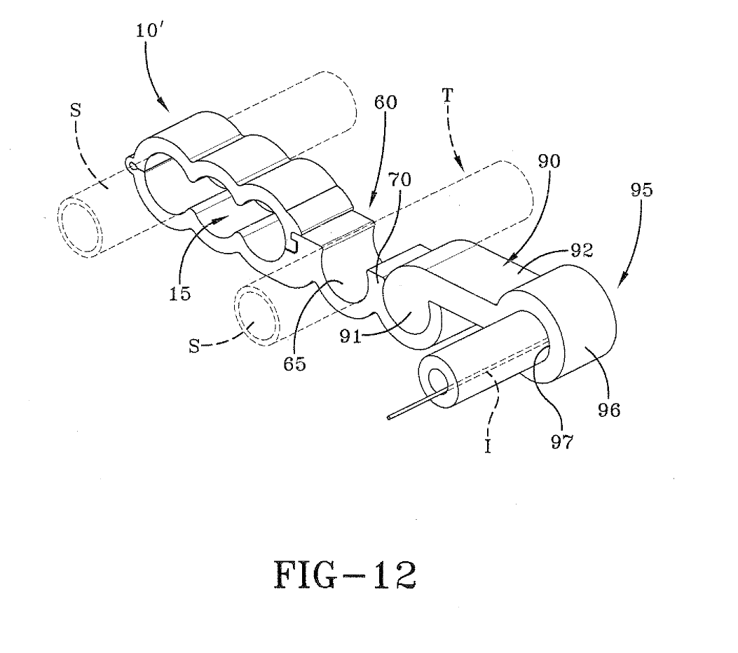

Alternatively as shown in FIGS. 9A and 9B, hanger 75 may be in the form of a projection 80. Projection 80 may be formed by a cylindrical end portion 81 and web 82 that extend longitudinally to the same extent as clip 10. As shown, cylindrical end portion 81 may have a larger vertical dimension than the adjacent neck portion 83 of web 82. This may facilitate gripping of projection 80 as by an accessory clip 85 or other item to be mounted on projection 80. For example, a common accessory packaged with a tube T is an accessory clip 85 (FIG. 11) that operates like a clothes pin and is provided with a circular recess 86 formed by opposing jaws 87. Cylindrical end portion 81 may be sized such that its diameter fits within the recess created by the clip's jaws 87.

As shown in FIGS. 9A and 9B, hanger 75 may extend from an open style clip, generally indicated by the number 210′. Open clip 210′ includes a wall 268 which is generally U-shaped and dividers 270 extending inward from a base 262 of the wall 268 to define plural primary open channels 265A-C adapted to receive a tube T. In addition, clip 210′ may have one or more channels 265D adapted to receive an adaptor, accessory, or tubing of different size or cross-section. For example, as shown in FIG. 11, an open clip 210′ defines a secondary channel 265D at one end of clip 210′. It will be appreciated that secondary channel 265D may be located at either end or in an intermediate position depending on the application. Secondary channel 265D is distinguished from primary channel(s) 265A-C in that it has a different geometry. For example, the geometry of the primary channels 265 A-C and secondary channel 265D may differ in terms on longitudinal dimension, lateral dimension, or cross section. For example, it is common to package accessories, like a flushing device 120 (FIG. 11) in the same package as a surgical instrument I held in the tube T. As shown, flushing device 120 includes a nozzle 122, which may be enclosed by a protective cap 124 that is generally smaller than tube T. Accordingly, open clip 210′ is provided with a secondary channel 265D having a lateral dimension similar to the diameter of flushing device 120 or cap 124 to secure flushing device 120 to open clip 210′. To facilitate flushing device 120, secondary channel 265D may be formed at a lateral outward extremity of open clip 210′. In the examples shown, secondary channel 265D is formed on an end of clip 210′ located radially outward relative to the loops of the coil C formed by tube T, which are secured in primary channels 265A-C.

As shown in FIG. 11, in some instances, tubes of different diameter may be attached to each other by way of an adapter A that may be received within one of the channels 265. In the example shown, adapter A fits on the end of tube T and is located in channel 265C. Adapter A includes a reducing section which narrows to a nose end adapted to fit within the internal diameter of a second tube T′. By providing the secondary channel 265D and hanger 75 in connection with any of the clips 10, 10′, 210, 210′ or in connection with an open channel portion 60 of a clip 10, a great deal of flexibility in terms on attaching various accessories, adapters, or other objects that are packaged with elongated surgical instrument I and tube T may be accommodated.

To provide even greater flexibility, a detachable adaptor, generally indicated by the number 90 may be provided. Detachable adaptor 90 may be secured within an open channel of an open clip or open clip portion 60. This adaptor 90 may include a boss 91 sized to fit within one channel 65 of the open clip portion 60. An arm 92 or other projection may extend outward from the boss 91. As shown in the FIG. 12, arm 92 may extend laterally outward from an upper portion of boss 91 such that arm 92 extends at or above the top surface of open clip portion 60. In the example shown, arm 92 extends laterally outward of the open clip portion 60. The arm 92 may be provided with an end 95 used to attach, house, or protect components or accessories packaged with the elongate surgical instrument. For example, as shown, end 95 may be in the form of a loop 96 defining an opening 97 therein for receipt of a portion of the surgical instrument I. Alternatively, end 95 may include a cap-like member capable of housing and enclosing a portion of the surgical instrument I.

The foregoing disclosure is illustrative of a present invention and is not to be construed as limiting thereof. Although one or more embodiments of the invention have been described, persons of ordinary skill in the art will readily appreciate that numerous modifications could be made without departing from the scope and spirit of the disclosed invention. Consequently, it should be understood that all such modifications are intended to be included within the scope of this invention. The description and drawings illustrate one or more exemplary embodiments of the present invention and are not to be considered or construed as limiting. For an appreciation of the scope of the invention, reference should be made to the following claims.

What is claimed:

1. A clip used in connection with a tube to hold sections of the tube adjacent to each other, the clip comprising:
a first section and a second section joined at one end by a hinge, said first and second sections each having end portions that extend inwardly toward each other and define a channel between said first and second sections when said end portions opposite said hinge are held in contact with each other;
a first ridge extending inward from an interior surface of said first section into said channel;
a second ridge extending inward from an interior surface of said second section into said channel;
wherein said first and second ridges are opposite one another to divide the channel into channel sections, said first and second ridges extending only partially into said channel defining a gap therebetween, whereby the sections of the tube within said channel sections may extend at least partially into said gap when adjacent to each other.

2. The clip of claim 1 further comprising a second pair of opposing ridges extending inwardly into said channel and spaced laterally from said first pair of ridges, wherein said first and said second pairs of ridges divide the channel into three channel sections;
wherein said second pair of ridges defines a gap therebetween whereby sections of tube within said three channel sections may extend at least partially into the gaps between said first and second pairs of ridges.

3. The clip of claim 1, wherein said end portions of said first and second sections opposite said hinge are joined by a clasp comprising a first clasp section formed on said first section and a second clasp section formed on said second section and attachable to each other to secure the end portions of said first and second sections together.

4. The clip of claim 3, wherein said first and second clasp sections include opposing L-shaped portions each defining a groove adapted to receive a leg of the opposing L-shaped clasp section.

5. The clip of claim 4, wherein said clasp sections are releasably attached to each other.

6. The clip of claim 1, wherein said hinge is a living hinge integrally formed with said first and second sections of the clip.

7. The clip of claim 1 further comprising an open clip portion extending from one of the first and second sections, said open clip portion comprising a U-shaped wall defining a channel external to said clip and adjacent thereto.

8. The clip of claim 7 further comprising a divider extending inward from a base of said channel formed by said open clip portion to define a pair of open channel sections respectively between said clip and said divider and said divider and said wall of said channel of said open clip portion, wherein said divider extends radially outward as it extends inward into said channel to define a mouth of each of the channel sections, wherein each mouth is narrower than a widest portion of each channel section.

9. The clip of claim 8 further comprising a hanger extending laterally outward from the lateral outward extremity of said open clip portion.

10. The clip of claim 9, wherein said hanger includes a post comprising a tab extending from said open clip portion and an end portion extending from the lateral outward extremity of said tab, said end portion being larger than said tab in a vertical dimension and forming a shoulder therebetween.

11. The clip of claim 9, wherein said hanger includes a projection comprising a cylindrical end portion connected to a lateral outward extremity of said open clip portion by a web, said web having a neck portion adjacent to said cylindrical end portion, said cylindrical end portion having a larger vertical dimension than the neck portion.

12. The clip of claim 1 further comprising a hanger extending laterally outward from one end of said clip, said hanger comprising a tab extending from said clip having an end portion at its lateral outward extremity, wherein said end portion is larger than said tab in a vertical dimension and forms a shoulder therebetween.

13. The clip of claim 1 further comprising a hanger extending laterally outward from one end of the clip, said hanger comprising a web extending laterally outward from said clip, said web having a neck at its lateral outward extremity and a cylindrical end portion extending from said neck, said cylindrical end portion having a larger vertical dimension than said neck forming a shoulder therebetween.

14. The clip of claim 7 further comprising a detachable adapter having a boss adapted to be received within the channel defined by said open clip portion and an arm extending outward from said boss, and an end formed at an extremity of said arm.

15. The clip of claim 14, wherein said end of said arm defines an opening adapted to receive a portion of the surgical instrument or a surgical accessory.

16. The clip of claim 14, wherein said end of said arm includes a cap that defines a chamber that is open at one end.

17. A clip used in connection with a tube to package a surgical instrument or a surgical accessory, the clip comprising:
a generally U-shaped wall having a base and at least one divider extending inward from said base to define a primary channel, and
a secondary channel, said secondary channel having a different geometry than said primary channel.

18. The clip of claim 17, wherein said secondary channel has a smaller lateral dimension than said primary channel.

19. The clip of claim 17 further comprising a hanger extending from an end of said wail, said hanger including a gripable surface for attachment of the surgical accessory.

20. A clip used in connection with a tube having sections arranged to form a coil, the clip comprising:
a first section and a second section joined at one end by a hinge and at an opposite end by a clasp to define a channel between said first and second sections; and
a first pair of ridges where each ridge is an opposing relationship with the other and extends inwardly from a respective first and second section partially into said channel defining a gap therebetween and dividing said channel into channel sections;
whereby the sections of the tube are received in said channel sections and extend toward contact with each other in the gap formed between said ridges.
